(19) United States
(12) Patent Application Publication
(10) Pub. No.: US 2018/0050786 A1
(43) Pub. Date: Feb. 22, 2018

(54) DRAIN MAST OF AN AIRCRAFT

(71) Applicant: Airbus Operations, S.L., Getafe (ES)

(72) Inventors: Carlos CASADO MONTERO, Getafe (ES); José Ángel HERNANZ MANRIQUE, Getafe (ES); Alberto MOLINA, Getafe (ES)

(21) Appl. No.: 15/677,205

(22) Filed: Aug. 15, 2017

(30) Foreign Application Priority Data
Aug. 22, 2016 (EP) 16382400.6

(51) Int. Cl. B64C 1/14; B64D 41/00

(52) U.S. Cl. CPC B64C 1/1453; B64D 41/00

(57) ABSTRACT

A drain mast for draining liquids from an aircraft. The drain mast comprises a tube and further comprises a pipe coupled to the inner longitudinal surface of the tube and configured such that the drained liquid flows from the tube to the pipe. The pipe has an inlet having its longitudinal axis configured to confront the coming airflow for allowing the inlet of the coming airflow into the pipe, and an outlet having its longitudinal axis inclined with respect to the longitudinal axis of the inlet and configured to discharge the airflow flowing through the pipe in a direction inclined with a component perpendicular to the fuselage of the aircraft.

### CROSS-REFERENCES TO RELATED APPLICATIONS

This application claims the benefit of the European patent application No. 16382400.6 filed on Aug. 22, 2016, the entire disclosures of which are incorporated herein by way of reference.

### FIELD OF THE INVENTION

The present invention relates to a drain mast of a compartment, receptacle or piping of an aircraft intended to drain a fluid, more particularly, to the drain mast of the compartment of an auxiliary power unit (APU) of an aircraft.

### BACKGROUND OF THE INVENTION

Known drainage systems of the auxiliary power unit (APU) of an aircraft comprise a mast for evacuating any liquid accumulated in the APU compartment to the atmosphere by gravity or pressure differential. Masts are supposed to release both small portions of fluid and large fluid leakages, this last case being the sizing case.

As described above, a drain mast is intended to evacuate fluid as a result of a failure, malfunction or similar. Being this purpose the first criteria to satisfy for certification, it is usually accompanied with the requirement, in case of flammable fluids, of preventing the drained liquid from impinging onto an external hot area of the aircraft that could start a fire.

For satisfying that second requirement, the mast should prevent the fluid from attaching to the skin of the fuselage. Sometimes, it is not a question of safety but it is a cosmetic issue where the fluid, oil in this case, creates stains causing inspections, complaints or cleaning operations.

The known APU drain mast comprises a tube with or without a chamfered end. The tube comprises:
a first end configured for being connected to the compartment of the aircraft,
a second end configured for discharging the liquid to the atmosphere,
an inner surface configured for being exposed to the drained liquid, and
an outer surface that can be exposed to the airflow surrounding the drain mast.

Each drain mast usually has a receptacle intended to receive the fluid from any source. This receptacle is able to lead the fluid towards the final tube. The shape of the mast causes the droplets of fluid to run through the inner surface of the tube and finally they are released to the ambient. Therefore, the liquid film runs freely in the inner wall of the tube.

In case of having small leakages, the droplets are not always well released and it is frequent that once a droplet achieves the open end of the tube, instead of being released to the atmosphere, it is adhered to the outer surface of the tube going up till the fuselage because when the aircraft is flying the airflow can be powerful enough to promote the droplet to the rear outer surface of the drain mast or they are released and adhered to the fuselage by the airflow.

In addition to the previously stated drawbacks related to the improper release of the droplets, these masts are also a source of parasite drag to the aircraft.

The invention herein described tries to avoid these phenomena.

### SUMMARY OF THE INVENTION

The invention has been applied to the APU compartment but it can also be applied to other areas of the aircraft where drain masts are located.

An object of the invention is to control the droplets leaking path in order to avoid fuselage contamination without impacting in the parasitic drag.

The claimed drain mast comprises a pipe coupled to the inner longitudinal surface of the tube of the drain mast and configured such that the drained liquid flows from the tube to the pipe. The drain mast further comprises:
an inlet having its longitudinal axis configured for confronting the coming airflow for allowing the inlet of the coming airflow into the pipe, and,
an outlet having its longitudinal axis inclined with respect to the longitudinal axis of the inlet and configured for discharging the airflow and the drained liquid flowing through the pipe in a direction inclined with a component perpendicular to the fuselage of the aircraft.

The pipe could further comprise a duct diametrically located in a cross-section of the pipe and having an end coupled to the inner longitudinal surface of the tube such that the drained liquid flows from the tube to the pipe through the duct, the duct further comprising an opening in the side of the duct pointing towards the airflow direction, i.e., in the face of the duct opposite to the incoming airflow, such that the opening creates a suction effect that sucks the drained liquid from the duct to the pipe.

The invention discloses, therefore, a tube connectable to the below part of the compartment that avoids the adherence of droplets to the fuselage by a further pipe having an inlet allowing the entrance of the coming airflow as it is located confronted to the free air stream. The air is accelerated into the pipe since the flow close to the fuselage is low energy air. Optionally, at a certain stage of the pipe could be a duct, having its longitudinal axis diametrically located with respect to a cross-section of the pipe, and having an opening into the pipe that drains the evacuated liquid into the pipe.

The accelerated airflow creates a suction effect that sucks the drained liquid drops from the tube to the pipe and then they are released to the atmosphere.

Drops are broken into multiple and smaller droplets that are further accelerated due to the smaller size. In order to reach an optimum size of the droplets, a Mach number of 0.3 would be advisable.

The longitudinal axis of the outlet of the pipe is inclined with respect to the longitudinal axis of the inlet and also with respect to the longitudinal axis of the fuselage such that the pipe provides at its outlet a velocity component inclined to the free airstream. Thanks to this component, the fluid will be ejected opposite to the fuselage by the drain mast, therefore avoiding its adherence to it.

The claimed drain mast achieves the following phenomena:

first of all, drops are broken up thus generating a fine spray once they are ingested into the flow of the pipe, in the remaining piping length the small droplets are accelerated.

afterwards the spray is discharged to the ambient, inclined with a certain angle and having a perpendicular component to the free airstream thanks to the second part of the pipe that provides the fluid with a momentum having a perpendicular component to the free airstream.

Therefore, two advantages of the device are that it guarantees the correct detachment of the drop or drops from the drain mast and it provides the released fluid/drops with a velocity component that ejects the fluid far from the skin of the fuselage. Once the drop is ingested in the accelerated flow of the pipe, a spray is formed and fully developed, this spray allows to reduce the momentum response time and, therefore, to accelerate the fluid in a shortest distance.

The claimed drain mast has reduced dimensions, is light and easy to manufacture as well as a non-expensive system. Another advantage is that there are no changes in the compartment design of the aircraft and it is easy to attach to the wall of the compartment.

It is also an object of the present invention an auxiliary power unit of an aircraft comprising a drain mast according to the above technical features and an aircraft comprising a drain mast according to the above technical features.

### BRIEF DESCRIPTION OF THE DRAWINGS

FIGS. 1A and 1B show schematic longitudinal and cross sections of a drain mast of the state of the art showing the behavior of a fluid droplet.

FIG. 2 shows a schematic longitudinal section of an embodiment of the drain mast.

FIG. 3 shows a schematic view showing the pipe and duct of the embodiment of FIG. 2.

FIG. 4 shows a schematic representation of an embodiment of the pipe.

FIGS. 5 and 6 show schematic representations of a fairing of the embodiment shown in FIG. 2.

### DETAILED DESCRIPTION OF THE PREFERRED EMBODIMENTS

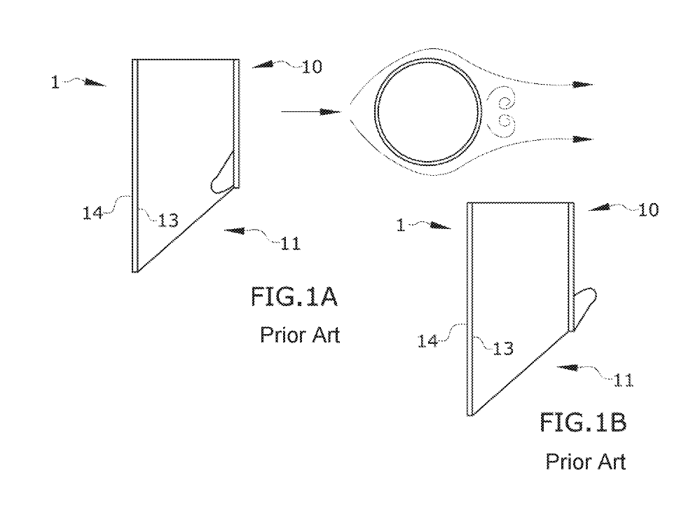

FIG. 1A illustrates the basic components of a known drain mast of an APU compartment of an aircraft, the drain mast comprising a tube (1) having a first end (10) connected to the APU compartment and a second end (11) for discharging the liquids to the atmosphere. The APU compartment is usually located in the tail cone of the aircraft close to the fuselage and receives the liquids leaked by the APU. The tube (1) could also be connected to a receptacle or piping of the aircraft intended to drain a fluid.

As can be seen in FIGS. 1A and 1B, the distribution of the airflow in the outer surface (14) of the tube (1) opposite to the surface facing the coming airflow promotes the adherence of the droplets of liquid to the outer surface (14) of the tube (1) such that the droplet runs over the outer surface (14) as it is depicted in FIG. 1B. As previously stated, another option is that the drop or drops are firstly released to the atmosphere but afterwards adhered again to the fuselage by the airflow.

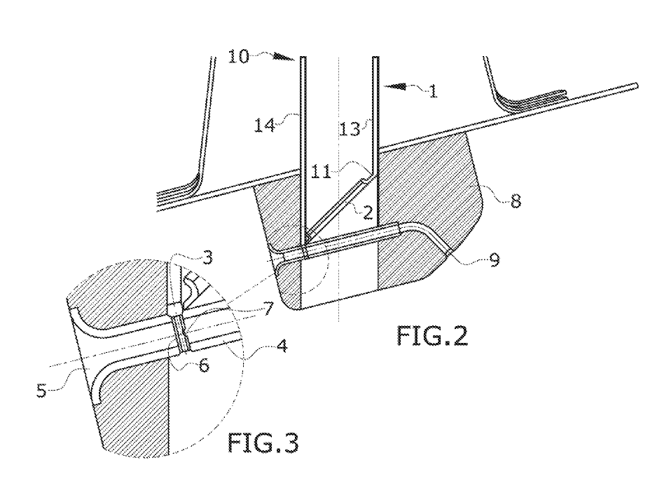

FIG. 2 shows an embodiment of the invention in which the drain mast has the tube (1) comprising:
a first end (10) connected to the compartment of the aircraft,
a second end (11) for discharging the liquids to the atmosphere and additionally this second end (11) could be configured for being located in a plane inclined with respect to the fuselage,
an inner longitudinal surface (13) configured for being exposed to the drained liquid, and
an outer longitudinal surface (14),

The pipe (4) comprises an inlet (5) allowing the entrance of the coming airflow and an outlet (9) that has its longitudinal axis inclined with respect to the longitudinal axis of the inlet (5).

The depicted embodiment also comprises a duct (6) located diametrically with respect to the pipe (4) and having an end coupled to the inner longitudinal surface (13) of the tube (1) such that the drained liquid flows from the tube (1) to the duct (6). The duct (6) further comprises an opening (7) in the side of the duct (6) pointing towards the airflow direction or, what is the same, the opening (7) is located in the face of the duct (6) opposite to the face of the duct (6) facing the incoming flow.

FIG. 3 shows that the opening (7) of the duct (6) is located in the center of the cross-section of the pipe (4), wherein the maximum speed for the airflow is obtained, although the opening (7) could be located in a different location or the duct (6) can comprise several openings (7) in the face of the duct (6) that is located opposite to the incoming airflow, or, in the worst case, even not having a duct (6) and therefore the tube (1) directly discharging to the pipe (4).

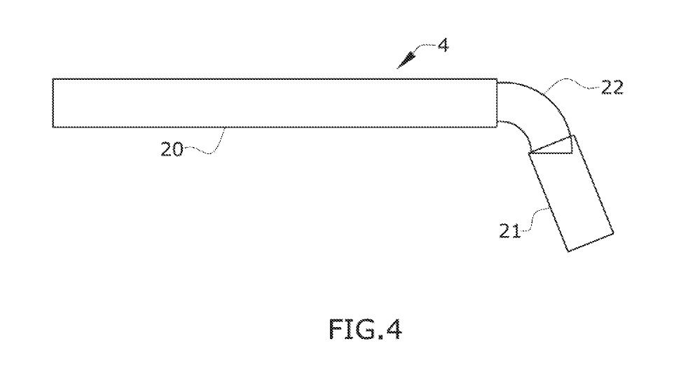

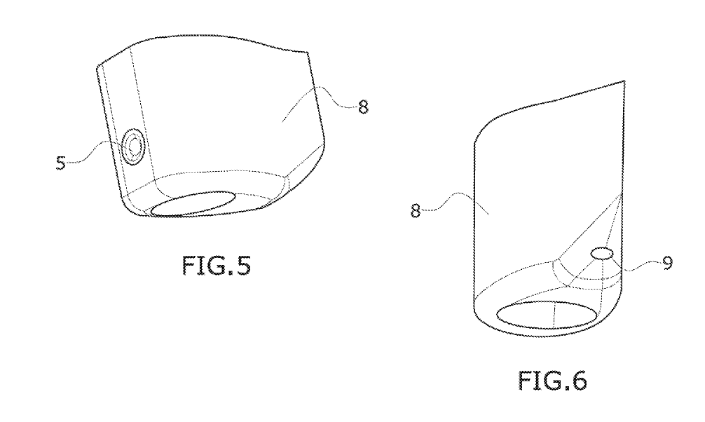

More specifically, FIG. 4 shows an embodiment wherein the pipe (4) comprises a first straight part (20) in which the drops are released into the pipe (4) and accelerated and a second straight part (21) in which the drops are finally released to the atmosphere with an inclination with respect to the first straight part (20). The pipe (4) also comprises a bended part (22) located in between the first and the second straight parts (20, 21). The first part (20) has to be long enough to provide enough speed to the drops, obtaining a quick acceleration of them. More specifically the length of the first part (20) of the pipe (4) is between 5-22 mm to fully develop the spray.

The spray is accelerated along the first part (20) of the pipe (4), due to the small size of the droplets and the coming airflow, the inertia forces has less effect and therefore the pipe (4) can be bended avoiding in such a way a possible adherence of the spray to the inner walls of the pipe (4).

To lead the liquid coming from the walls of the tube (1) to the pipe (4) or to duct (6) are several solutions, one is to incline the tube (1) rearwards then forcing to fall down the fluid onto the inner front face of the tube (1) and run down by gravity through this face. In this case, the longitudinal axis of the tube (1) is located in an inclined position with respect to the fuselage of the aircraft.

Another embodiment is that the second end (11) of the tube (1) further comprises:
an internal rim (2) located at its second end (11) connected to the inner surface (13) of the tube (1) and configured for being located in a plane inclined with respect to the horizontal plane of the fuselage, the internal rim (2) further comprising an aperture (3) being located at the lowest part of the internal rim (2) for draining the liquid,
the internal rim (2) and the aperture (3) being configured such that at the second end (11) the liquid is directed by gravity through the internal rim (2) to the aperture (3).

The internal rim (2) can be located in a tube (1) having a chamfered end (11) the rim (2) being located following the profile of the chamfered end (11) or it can be located in a tube (1) with a straight end being the rim (2) in a plane inclined with respect to the fuselage.

Therefore, drops approaching the open end runs by gravity over the internal rim (2) and are guided to the second end (11) thanks to its inclination and thus to the inclination of the internal rim (2) connected to the second end (11).

The drain mast also comprises a fairing (8) having an aerodynamic shape to reduce drag, the fairing (8) surrounds the pipe (4) and the end of the tube (1). The faring (8) comprises two orifices, the inlet (3) and the outlet (9) of the pipe (4).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A drain mast for draining liquids from an aircraft, the drain mast comprising a tube comprising:
a first end configured to connect to a source of liquids to be drained from the aircraft,
a second end configured to discharge said liquids to the atmosphere,
an inner longitudinal surface configured to be exposed to the drained liquid, and
an outer longitudinal surface,
a pipe coupled to the inner longitudinal surface of the tube and configured such that the drained liquid flows from the tube to the pipe, the pipe comprising:
an inlet having its longitudinal axis configured to confront with the coming airflow for allowing the inlet of said coming airflow into the pipe, and
an outlet having its longitudinal axis inclined with respect to the longitudinal axis of the inlet and configured to discharge the airflow and the drained liquid flowing through the pipe in a direction inclined with a component perpendicular to the fuselage of the aircraft.

2. The drain mast for draining liquids according to claim 1, wherein the pipe further comprises a duct diametrically located in a cross-section of the pipe and having an end coupled to the inner longitudinal surface of the tube such that the drained liquid flows from the tube to the pipe through the duct, the duct further comprising an opening in the side of the duct pointing towards the airflow direction such that the opening and the airflow create a suction effect that sucks the drained liquid from the duct to the pipe.

3. The drain mast for draining liquids according to claim 2, wherein the opening of the duct is located in a center of the cross-section of the pipe.

4. The drain mast for draining liquids according to claim 2, wherein the duct comprises several openings in the side of the duct pointing towards the airflow direction.

5. The drain mast for draining liquids according to claim 1, wherein a longitudinal axis of the tube is configured to be located in an inclined position with respect to the fuselage of the aircraft.

6. The drain mast for draining liquids according to claim 1, wherein the second end of the tube is configured to be located in a plane inclined with respect to the fuselage of the aircraft.

7. The drain mast for draining liquids, according to claim 1, wherein the tube further comprises an internal rim located at its second end connected to the inner surface of the drain mast, the internal rim further comprising an aperture being located at the lowest part of the internal rim for draining the liquid, the internal rim and the aperture being configured such that at the second end the liquid is directed by gravity through the internal rim to the aperture.

8. The drain mast for draining liquids, according to claim 1, further comprising a fairing enclosing the pipe and the second end of the tube and having an aerodynamic shape for reducing drag.

9. The drain mast for draining liquids, according to claim 1, wherein the pipe comprises a first straight part wherein the liquid is released into the pipe and accelerated, a second straight part wherein the accelerated liquid is released to the atmosphere, having the second straight part inclined with respect to the first straight part, and a bent part located in-between the first and the second straight parts.

10. An auxiliary power unit of an aircraft comprising a drain mast according to claim 1.

11. An aircraft comprising a drain mast according to claim 1.
